(19) United States
(12) Patent Application Publication
(10) Pub. No.: US 2023/0218009 A1
(43) Pub. Date: Jul. 13, 2023

(54) AEROSOL PROVISION DEVICE AND METHOD

(71) Applicant: Nicoventures Trading Limited, London (GB)

(72) Inventors: Matthew Howard, London (GB); Simon Poynton, London (GB); Tomi Vintola, London (GB)

(21) Appl. No.: 17/996,331

(22) PCT Filed: Apr. 19, 2021
(86) PCT No.: PCT/GB2021/050929

§ 371 Date: Oct. 14, 2022

(30) Foreign Application Priority Data
Apr. 17, 2020 (GB) 2005623.0

(51) Int. Cl. A24F 40/50; A24F 40/90

(52) U.S. Cl. CPC A24F 40/50; A24F 40/90

(57) ABSTRACT

An apparatus and a method is described comprising: charging a battery of an aerosol generating device in a first mode of operation when a charge level of the battery is below a first threshold; and charging the battery of the aerosol generating device in a second mode of operation when the charge level of the battery is above the first threshold.

### PRIORITY CLAIM

The present application is a National Phase entry of PCT Application No. PCT/GB2021/050929, filed Apr. 19, 2021, which claims priority from GB Application No. 2005623.0, filed Apr. 17, 2020, each of which is hereby fully incorporated herein by reference.

### TECHNICAL FIELD

The present specification relates to an aerosol provision device and a method of using such a device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol generating substrate such as tobacco to form an aerosol by heating, but not burning, the substrate.

### SUMMARY

In a first aspect, this specification describes an apparatus for an aerosol generating device, the apparatus comprising a charging controller, wherein: the charging controller is configured to control charging of a battery at a first charging rate when a charge level of the battery is below a first threshold; and the charging controller is configured to control charging of the battery at a second charging rate, lower than the first charging rate, when the charge level of the battery is above the first threshold. The apparatus may include said battery. The apparatus may include an aerosol generator. In some example embodiments, a third charging rate may be provided, lower than the second charging rate, when the charge level of the battery is above a second threshold. In some example embodiments, the apparatus may be a charging case (e.g. for charging an aerosol generating device). Further, the aerosol generating device may be charged under the control of the charging case and may, in use, be separated from the charging case.

The apparatus may further comprise an adaptive charging module. The adaptive charging module may, for example, form part of the charging controller or may be provided as a separate module. In some example embodiments, the adaptive charging module is configured to set the first threshold.

An adaptive charging module may be configured to learn charging patterns (e.g. when and/or at what rate charging occurs) of the aerosol generating device, wherein the first threshold is set depending, at least in part, on the learnt charging patterns. Alternatively, or in addition, an adaptive charging module may be configured to learn usage patterns of the aerosol generating device, wherein the first threshold is set depending, at least in part, on the learnt usage patterns. Alternatively, or in addition, an adaptive charging module may be configured to learn usage patterns of a user of the aerosol generating device.

In some example embodiments, the adaptive charging module is implemented using a machine-learning module.

The first threshold may be set dependent on a usage level of the aerosol generating device. For example, the first threshold may be set at a level at which a defined number of operations of the aerosol generating device can be actuated. An “operation” may be a puff or a session, as discussed further below.

The first threshold may be set at a level at which an anticipated usage time of the aerosol generating device can be achieved.

The first threshold may be set to enable one day of expected operation of the aerosol generating device. Alternatively, or in addition, the first threshold may be set to enable an expected level of operation until a next anticipated charging time.

The first threshold may be dependent on a determined normal user operation of the aerosol generating device.

The first threshold may be set dependent on one or more of: a current day of the week; a current time of day; first user habits as input by the user; second user habits as determined through use; one or more properties of an aerosol generating material; one or more battery properties (e.g. battery age or a proxy for battery age); and one or more user settings.

In a second aspect, this specification describes a method comprising: charging a battery of an aerosol generating device in a first mode of operation when a charge level of the battery is below a first threshold; and charging the battery of the aerosol generating device in a second mode of operation when the charge level of the battery is above the first threshold. The method may further comprise setting the first threshold. A third charging rate may be provided, lower than the second charging rate, when the charge level of the battery is above a second threshold. The method may include setting the second threshold. The method may be implemented by the aerosol generating device. Alternatively, the method may be implemented at a charging case or charging device used for charging the aerosol generating device.

The first threshold may be set dependent on a use level of the aerosol generating device.

The first threshold may be set dependent on one or more of: a current day of the week; a current time of day; first user habits as input by the user; second user habits as determined through use; one or more properties of an aerosol generating material; one or more battery properties; and one or more user settings.

The first threshold may be set at a level at which a defined number of operations (e.g. puffs) of the aerosol generating device can be actuated. Alternatively, or in addition, the first threshold may be dependent on a determined normal user operation.

The method may further comprise learning charging patterns (of the user or the of the aerosol generating device), wherein the first threshold is set depending on the learnt charging patterns. The charging patters may comprise when and how the user typically charges a device and/or when and how a particular device is typically charged. Alternatively, or in addition, the method may further comprise learning usage patterns (of the user or of the aerosol generating device), wherein the first threshold is set depending on the learnt usage patterns. The said patterns may be learnt using a machine learning module.

In a third aspect, this specification describes a non-combustible aerosol generating device comprising an apparatus (e.g. a tobacco heating system) including any of the features of the first aspect. The aerosol generating device may be configured to receive a removable article comprising an aerosol generating material. The aerosol generating material may comprise an aerosol generating substrate and an aerosol forming material.

In a fourth aspect, this specification describes an aerosol provision system for generating aerosol from an aerosolizable material, the aerosol provision system comprising an apparatus including any of the features of the first aspect describes above or a device including any of the features of the third aspect describes above.

In a fifth aspect, this specification describes computer-readable instructions which, when executed by computing apparatus, cause the computing apparatus to perform any method as described with reference to the second aspect.

In a sixth aspect, this specification describes a kit of parts comprising an article (e.g. a removable article comprising an aerosol generating material) for use in a non-combustible aerosol generating system, wherein the non-combustible aerosol generating system comprises an apparatus including any of the features of the first aspect described above or a device or system including any of the features of the third or fourth aspects described above.

### BRIEF DESCRIPTION OF THE DRAWINGS

Example embodiments will now be described, by way of example only, with reference to the following schematic drawings, in which:

FIG. 1 is a block diagram of a system in accordance with an example embodiment;

FIGS. 2 and 3 are block diagrams of non-combustible aerosol provision devices in accordance with example embodiments;

FIG. 4 is a flow chart showing an algorithm in accordance with an example embodiment;

FIGS. 5 to 7 are plots demonstrating example uses of example embodiments;

FIG. 8 is a block diagram of a system in accordance with an example embodiment;

FIGS. 9 to 11 are flow charts showing algorithms in accordance with example embodiments;

FIG. 12 shows a neural network used in some example embodiments;

FIG. 13 is a block diagram of a system in accordance with an example embodiment; and

FIG. 14 is a block diagram of a system in accordance with an example embodiment.

### DETAILED DESCRIPTION OF THE DRAWINGS

As used herein, the term “delivery system” is intended to encompass systems that deliver a substance to a user, and includes:

combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);

non-combustible aerosol provision systems that release compounds from an aerosolizable material without combusting the aerosolizable material, such as electronic cigarettes, tobacco heating products, and hybrid systems to generate aerosol using a combination of aerosolizable materials;

articles comprising aerosolizable material and configured to be used in one of these non-combustible aerosol provision systems; and

aerosol-free delivery systems, such as lozenges, gums, patches, articles comprising inhalable powders, and smokeless tobacco products such as snus and snuff, which deliver a material to a user without forming an aerosol, wherein the material may or may not comprise nicotine.

According to the present disclosure, a “combustible” aerosol provision system is one where a constituent aerosolizable material of the aerosol provision system (or component thereof) is combusted or burned in order to facilitate delivery to a user.

According to the present disclosure, a “non-combustible” aerosol provision system is one where a constituent aerosolizable material of the aerosol provision system (or component thereof) is not combusted or burned in order to facilitate delivery to a user.

In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolizable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolizable material, an aerosol generating component, an aerosol generating area, a mouthpiece, and/or an area for receiving aerosolizable material.

In one embodiment, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In one embodiment, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12.

The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavors, carriers, pH regulators, stabilizers, and/or antioxidants.

In one embodiment, the article for use with the non-combustible aerosol provision device may comprise aerosolizable material or an area for receiving aerosolizable material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it.

The aerosolizable material may be present on a substrate. The substrate may, for example, be or comprise paper, card, paperboard, cardboard, reconstituted aerosolizable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

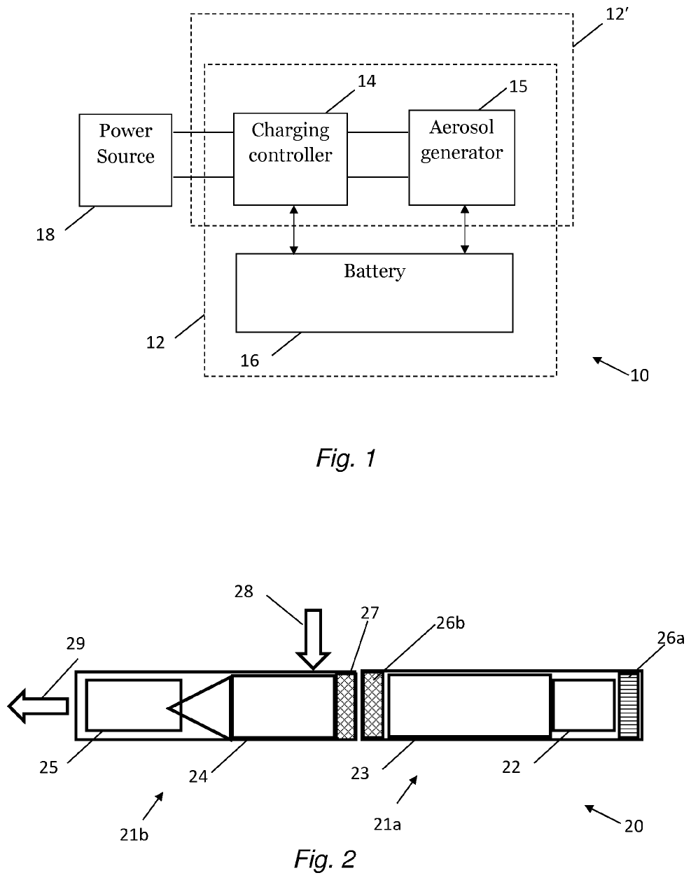

FIG. 1 is a block diagram of a system, indicated generally by the reference numeral 10, in accordance with an example embodiment. The system 10 comprises a charging controller 14, an aerosol generator 15, a battery 16 and a power source 18. The charging controller 14, the aerosol generator 15 and the battery 16 may form an aerosol generating device 12. Alternatively, the charging controller 14 and the aerosol generator 15 may form an aerosol generating device 12′ having an external battery 16. In a further alternative, the charging controller 14 may form part of a charging module or a charging case that can be used to charge the battery 16 of the aerosol generator 15. The aerosol generator (including the battery) may then be removed from the charging module or case for use in generating an aerosol.

As discussed in detail below, the charging controller 14 is configured to control charging of the battery 16, for example at a first charging rate or a second charging rate, depending on the charge level of the battery.

FIG. 2 is a block diagram of a non-combustible aerosol provision device, indicated generally by the reference numeral 20, in accordance with an example embodiment. The aerosol provision device 20 is an example implementation of the aerosol generating device 12 described above. The device 20 is a modular device, comprising a first part 21a and a second part 21b.

The first part 21a of the device 20 includes a control circuit 22 (which may include the charging controller 14 of the device 12) and a battery 23 (such as the battery 16 described above). The second part 21b of the device 20 includes a heater 24 and a liquid reservoir 25 (that may collectively form of the aerosol generator 15 of the system 10 described above).

The first part 21a includes a first connector 26a (such as a USB connector). The first connector 26a may enable connection to be made to a power source (such as the power source 18 described above) for charging the battery 23, for example under the control of the control circuit 22 (e.g. under the control of the charging controller 14).

The first part 21a also includes a second connector 26b that can be removably connected to a first connector 27 of the second part 21b.

In the use of the device 20, air is drawn into an air inlet of the heater 24, as indicated by the arrow 28. The heater is used to heat the air (e.g. under the control of the circuit 23). The heated air is directed to the liquid reservoir 25, where an aerosol is generated. The aerosol exits the device at an air outlet, as indicated by the arrow 29 (for example into the mouth of a user of the device 20).

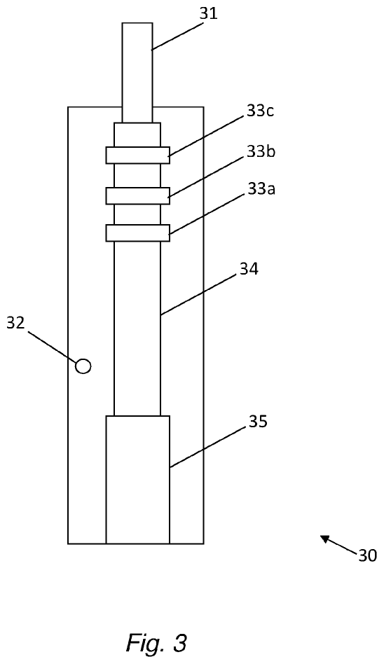

FIG. 3 is a block diagram of a non-combustible aerosol provision device, indicated generally by the reference numeral 30, in accordance with an example embodiment. The aerosol provision device 30 is an example implementation of the aerosol generator 15 of the system 10 and may also include other elements of the system 10.

FIG. 3 is a perspective view of the aerosol provision device 30 without an outer cover. The aerosol provision device 30 may comprise a replaceable article 31 that may be inserted in the aerosol provision device 30 to enable heating of the article 31. The aerosol provision device 30 further comprises an activation switch 32 that may be used for switching on or switching off the aerosol provision device 30, a plurality of heating elements 33a, 33b and 33c, and one or more air tube extenders 34 and 35. The one or more air tube extenders 34 and 45 may be optional.

The heating elements 33a, 33b and 33c may be heaters that directly heat the article 31. Alternatively, the heating elements 33a, 33b and 33 may be inductive heating elements that are configured to interact with a susceptor comprised within the article 31 (or provided elsewhere). The use of three heating elements 33a, 33b and 33c is not essential to all example embodiments. Thus, the aerosol generating device 30 may comprise one or more heating elements.

A susceptor may be provided as part of the article 31. In an example embodiment, when the article 31 is inserted in aerosol generating device, the aerosol generating device 30 may be turned on due to the insertion of the article 31. When the aerosol generating device 30 is turned on, the (inductive) heating elements 33 (e.g. inductive heating elements) may cause the article 31 to be heated (e.g. inductively heated) through the susceptor. In an alternative embodiment, the susceptor may be provided as part of the aerosol generating device 30 (e.g. as part of a holder for receiving the article 31).

The two alternative aerosol provision devices 20 and 30 are provided by way of example only; many further variants and alternatives are possible.

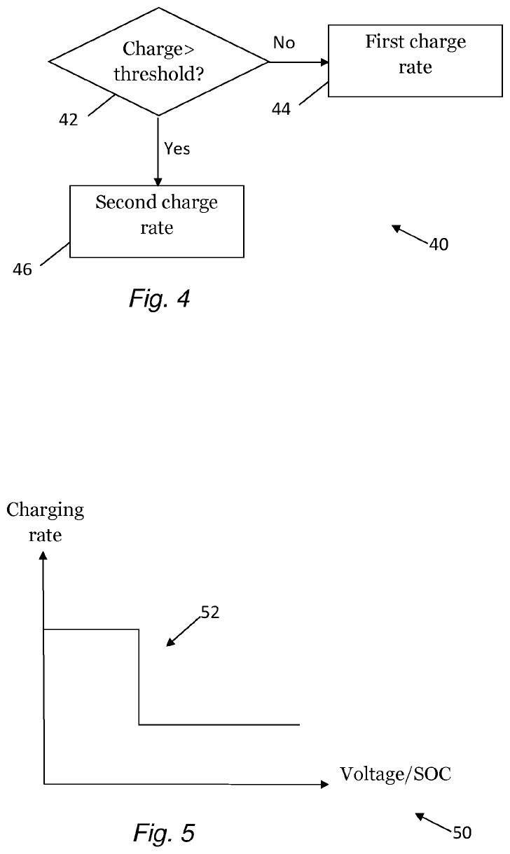

FIG. 4 is a flow chart showing an algorithm, indicated generally by the reference numeral 40, in accordance with an example embodiment. The algorithm 40 may be implemented by the systems 10, 20 or 30 described above.

The algorithm 40 starts at operation 42, where a determination is made regarding whether the relevant charge level (e.g. the charge level of the battery 16 or the battery 23) is above a first threshold.

If it is determined in the operation 42 that the charge level is below the threshold, then the algorithm 40 moves to operation 44, where the relevant battery is charged at a first charge level. If it is determined in the operation 42 that the charge level is above the threshold, then the algorithm moves to operation 46, whether the relevant battery is charged at a second charge level. The second charge level is lower than the first charge level, such that the battery is charged more quickly when the charge level is below the threshold than when the charge level is above the threshold. As noted below, there may be more than two charge levels (and hence more than one threshold) in some example embodiments.

FIG. 5 is a plot, indicated generally by the reference numeral 50, demonstrating an example use of an example embodiment. The plot 50 shows a charging rate of a device at different charge levels (e.g. different voltages or states of charge (SOC)). In the plot 50, charging of a battery is initially at a first charge level (when the voltage or state of charge is low), before being reduced to a second charge level (e.g. on detection that the charge level rises above the relevant charge threshold). In the plot 50, the transition between the first and second charge levels, indicated by the reference numeral 52, is sharp. The transition in the plot 50 may be at a particular state of charge (SOC) or a particular voltage level of the battery.

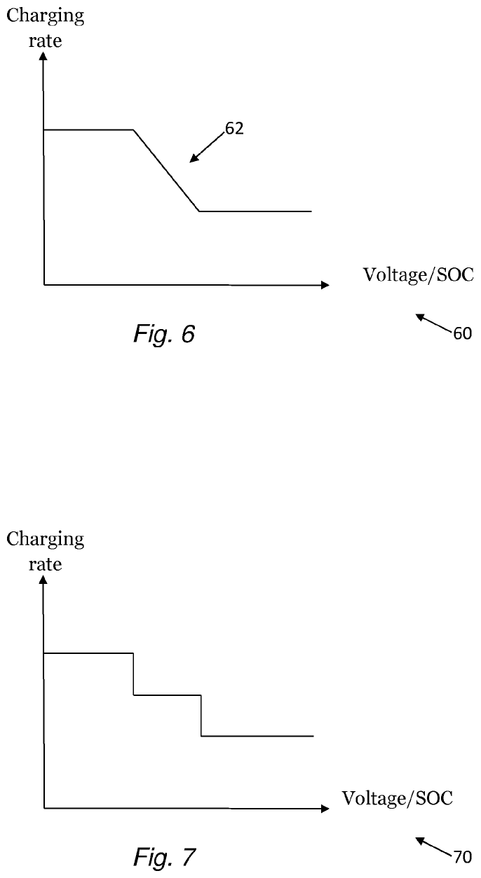

FIG. 6 is a plot, indicated generally by the reference numeral 60, demonstrating an example use of an example embodiment. In the plot 60, charging of a battery is initially at a first charge level, before being reduced to a second charge level (e.g. on detection that the charge level rises above the relevant charge threshold, e.g. a relevant state of charge of the battery). The plot 60 differs from the plot 50 in that, in the plot 60, the transition between the first and second charge levels, indicated by the reference numeral 62, is gradual.

FIG. 7 is a plot, indicated generally by the reference numeral 70, demonstrating an example use of an example embodiment. In the plot 70, charging of a battery is initially at a first charge level, before being reduced to a second charge level (e.g. on detection that the charge level rises above a first charge threshold, e.g. a first state of charge) and further reduced to a third charge level (e.g. on detection that the charge level rises above a second charge threshold, e.g. a second state of charge).

The plots 50, 60 and 70 are provided by way of example only. Many variants will be readily apparent to those of ordinary skill in the art.

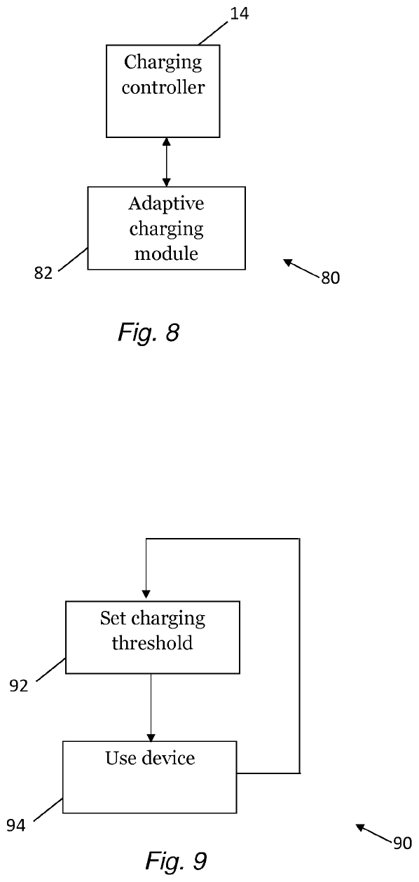

FIG. 8 is a block diagram of a system, indicated generally by the reference numeral 80, in accordance with an example embodiment. The system 80 comprises the charging controller 14 described above and further comprises an adaptive charging module 82. The adaptive charging module 82 may be provided as a separate module (as shown in FIG. 8), but could alternatively be provided as part of the charging module 14. The adaptive charging module may form a part of the aerosol generating device 12 or the aerosol generating device 12′ described above. Further, the adaptive charging module may form part of a charging module or case.

In some example embodiments, the adaptive charging module 82 is configured to set the first threshold (or one or more other thresholds) used, for example, in the algorithm 40 described above.

FIG. 9 is a flow chart showing an algorithm, indicated generally by the reference numeral 90, in accordance with an example embodiment.

The algorithm 90 starts at operation 92, where the first charging threshold described above (and potentially one or more other charging thresholds) is set. For example, the adaptive charging module 82 may be used to set the charging threshold(s) discussed above.

The algorithm 90 then moves to operation 94, where the device is used.

The algorithm may return (e.g. periodically) to operation 92 in which the first charging threshold may be reset (e.g. adjusted).

The first charging threshold set in the operation 92 may be set dependent on a usage level of the device being charged. For example, the first charging threshold may be set such that a particular usage of the device will be enabled when the first charging threshold is reached. For example, the first threshold may be set at a level based on a defined anticipated usage level or at a level at which a defined number of operations of the apparatus can be actuated (such as a single use or puff of the device, or a single session, wherein a “session” may be defined as the use of one consumable device, such as an insert for providing an aerosolizable material, a single day of usage of the device or a half-day of usage of the device). Alternatively, or in addition, the first threshold may be set such that a charge level of the device at the first threshold enables an expected level of operation of the device until a next anticipated charging time (or some other defined period). For example, the threshold might be lower in the afternoon than in the morning in the expectation of the device being charged overnight.

Many variables could potentially be used for setting the first charging threshold. Some examples are provided below. Of course, combinations of one or more the factors listed below may be used.
The day of the week. For example, one user may use the device more often on a weekday than at the weekend and another user might do the opposite. This may impact on power requirements and hence the optimum fast charging threshold.
The time of day. Daytime charging may be biased towards fast charging in expectation of imminent device usage. Slow charging may be used overnight (perhaps regardless of the current state of charge).
A user's habits. These might be input by a user, learned through use, or a combination of the two.
One or more properties of an aerosol generating material being used. For example, some aerosol generating materials may be associated with lower power requirements and some other materials may be associated with higher power requirements. For example, if a user switches from a low nicotine product to a high nicotine product, the power requirements might reduce and hence the fast charging threshold may be reduced.
One or more battery properties (e.g. age and/or temperature). For example, it may be preferred to charge older batteries more slowly.
One or more user settings (e.g. user indication of preference for fast charging or for maximizing battery lifetime).

The first threshold may be set to enable one day of expected or normal operation of the apparatus. (Of course, “expected” or “normal” operation may be defined in many ways, but may be based on data concerning actual usage of the device and/or data concerning usage of the device by the particular user.) The duration may also be different, for example the charging threshold may be set to enable a half-day of normal use.

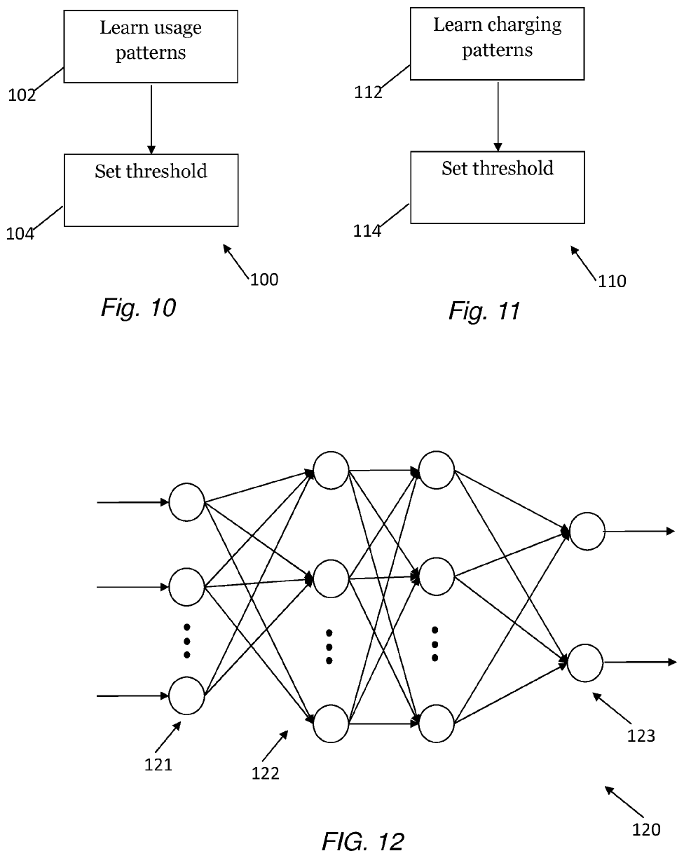

FIG. 10 is a flow chart showing an algorithm, indicated generally by the reference numeral 100, in accordance with an example embodiment. The algorithm 100 starts at operation 102, where usage patterns relating to a usage level of the device (or usage patterns of a particular user) are determined (e.g. learned). Next, at operation 104, the first threshold discussed above is set dependent (at least in part) on the usage patterns determined/learned in operation 102. Thus, the algorithm 100 is an example implementation of the operation 92 of the algorithm 90 described above.

For example, the user may have a predictable pattern of use through the day and the fast charging threshold can be adjusted accordingly. For example, usage may be highest shortly after lunchtime and in the evening. Moreover, as discussed above, usage may be different on different days (e.g. weekdays and weekends).

In one example embodiment, a user may return from home from work at a predictable time during weekdays and use the device for a few hours in the evening. After that, the device may typically be charged overnight. Thus, if the device is placed on charge when the user returns home, fast charging may be initiated so that the device has sufficient charge for the user's typical level of use in the evening. Once that level of charge is achieved, slow charging may be used; the fast charging threshold can be set accordingly.

FIG. 11 is a flow chart showing an algorithm, indicated generally by the reference numeral 110, in accordance with an example embodiment. The algorithm 110 starts at operation 112, where charging patterns relating to charging of the device (or charging patterns of a particular user) are determined (e.g. learned). The charging patterns may, for example, relate to when and/or at what rate charging occurs. Next, at operation 114, the first threshold discussed above is set dependent (at least in part) on the charging patterns determined/learned in operation 112. Thus, the algorithm 110 is an example implementation of the operation 92 of the algorithm 90 described above.

For example, a user may charge the device every night, for which a slow charge can be used (regardless of the current state of charge). Thus, when the overnight charge is started, the slow charging threshold could be set at (or close to) zero, so that the slow charging is used. Another user may typically only charge the device in short bursts; for that user, a high fast charging threshold might be appropriate.

The algorithms 100 and 110 could be combined such that usage patterns and charging patterns are both taking into account when setting a charging threshold.

Thus, the adaptive charging module 82 may be configured to learn usage patterns (see operation 102) and/or charging patterns (see operation 112), wherein the first threshold discussed above may be set depending on the learning usage and/or charging patterns.

In an example embodiment, the adaptive charging module 82 may be a model (such as a machine learning model) having a plurality of trainable parameters. By way of example, FIG. 12 shows a neural network, indicated generally by the reference numeral 120, used in some example embodiments. The neural network 120 includes a first layer 121, one or more hidden layers 122 and an output layer 123.

The input layer 121 may receive one or more inputs (for example from the charging controller 14). The inputs may be related to the use of the device or the charging of the device. The output layer 123 may provide one or more outputs of the adaptive charging module.

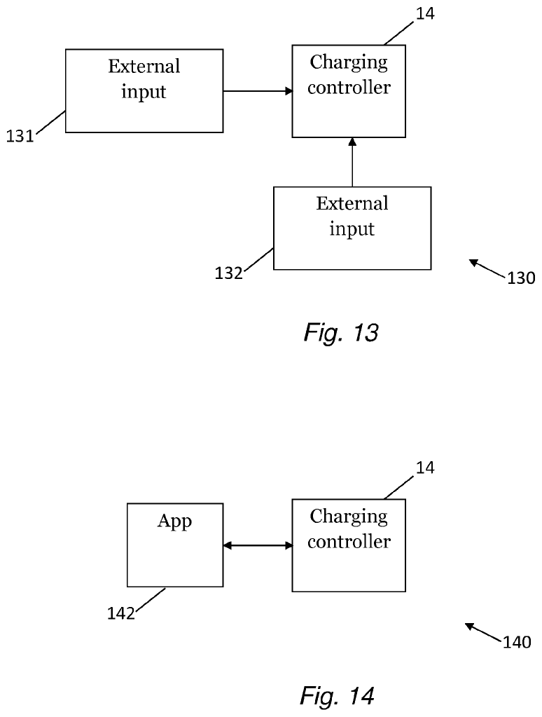

Many variants to the embodiments described above are possible. For example, FIG. 13 is a block diagram of a system, indicated generally by the reference numeral 130, in accordance with an example embodiment. The system 130 comprises the charging controller 14 described above, which charging controller receives a number of external inputs (a first external input 131 and a second external input 132 are provided by way of example only—more, fewer or different external inputs could be provided). The external inputs may provide information such as time and date information or location information and may be obtained, for example, using GPS information. By way of example, the charging controller 14 may be in communication with a GPS system or an inbuilt SIM card, or may be in communication with a mobile communication device (e.g. via a Bluetooth connection). One of more external data inputs may be used when setting threshold levels. For example, external data (such as location and/or the time of day) may be useful in estimating likely usage of the device and so may be used in the operation 100 for setting a threshold. Alternatively, or in addition, external data may be used in estimating likely charging patterns of the device (e.g. charging patterns overnight may be different to charging patters during the day) and so may be used in the operation 110 for setting a threshold.

FIG. 14 is a block diagram of a system, indicated generally by the reference numeral 140, in accordance with an example embodiment. The system 140 comprises the charging controller 14 described above and further comprises an application (app) 142 or some other means for providing user input to the charging controller 14. The application 142 may be used to enable a user to provide user settings (e.g. for use in setting the first charging threshold). By way of example, the user may indicate one or more of: expected usage amounts, expected charging times and user preferences (such as prioritizing fast charging or prioritizing battery life). Alternatively, or in addition, the application 142 may also receive information from the charging controller 14 for display to a user (such as the current charging mode).

As described above, the charging controller 14 may comprise part of an aerosol generating device. This is not essential to all example embodiments. For example, the charging controller 14 may form part of a charging case or some other charging module. An aerosol generating device may be charged using the charging case. Thus, for example, the system 130 may form a charging case that can be used to charge a separate aerosol generating device. Similarly, the application 142 may communicate with a charging controller of an aerosol generating device or with a charging controller of a charging case.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An apparatus for an aerosol generating device, the apparatus comprising a charging controller, wherein:
the charging controller is configured to control charging of a battery at a first charging rate when a charge level of the battery is below a first threshold; and
the charging controller is configured to control charging of the battery at a second charging rate, lower than the first charging rate, when the charge level of the battery is above the first threshold.

2. An apparatus as claimed in claim 1, further comprising an adaptive charging module.

3. An apparatus as claimed in claim 2, wherein the adaptive charging module is configured to set the first threshold.

4. An apparatus as claimed in claim 2, wherein the adaptive charging module is configured to learn charging patterns of the aerosol generating device, wherein the first threshold is set depending, at least in part, on the learnt charging patterns.

5. An apparatus as claimed in claim 2, wherein the adaptive charging module is configured to learn usage patterns of the aerosol generating device, wherein the first threshold is set depending, at least in part, on the learnt usage patterns.

6. An apparatus as claimed in claim 2, wherein the adaptive charging module is implemented using a machine-learning module.

7. An apparatus as claimed in claim 1, wherein the first threshold is set dependent on a usage level of the aerosol generating device.

8. An apparatus as claimed in claim 7, wherein the first threshold is set at a level at which a defined number of operations of the aerosol generating device can be actuated and/or a defined anticipated usage time of the aerosol generating device can be achieved.

9. An apparatus as claimed in claim 1, wherein the first threshold is set to enable one day of expected operation of the aerosol generating device.

10. An apparatus as claimed in claim 1, wherein the first threshold is set to enable an expected level of operation until a next anticipated charging time.

11. An apparatus as claimed in claim 1, wherein the first threshold is dependent on a determined normal user operation of the aerosol generating device.

12. An apparatus as claimed in claim 1, wherein the first threshold is set dependent on one or more of:
a current day of the week;
a current time of day;
first user habits as input by the user;
second user habits as determined through use;
one or more properties of an aerosol generating material;
one or more battery properties; and
one or more user settings.

13. An apparatus as claimed in claim 1, further comprising said battery.

14. An apparatus as claimed in claim 1, further comprising an aerosol generator.

15. A method comprising:
charging a battery of an aerosol generating device in a first mode of operation when a charge level of the battery is below a first threshold; and
charging the battery of the aerosol generating device in a second mode of operation when the charge level of the battery is above the first threshold.

16. A method as claimed in claim 15, further comprising setting the first threshold.

17. A method as claimed in claim 15, further comprising setting the first threshold dependent on a use level of the aerosol generating device.

18. A method as claimed in claim 15, wherein the first threshold is set at a level at which a defined number of operations of the aerosol generating device can be actuated.

19. A method as claimed in claim 15, wherein the first threshold is dependent on a determined normal user operation.

20. A method as claimed in claim 15, further comprising learning charging patterns of the aerosol generating device, wherein the first threshold is set depending on the learnt charging patterns.

21. A method as claimed in claim 15, further comprising learning usage patterns of the aerosol generating device, wherein the first threshold is set depending on the learnt usage patterns.

22. A method as claimed in claim 15, wherein the first threshold is set dependent on one or more of:
a current day of the week;
a current time of day;
first user habits as input by the user;
second user habit as determined through use;
one or more properties of an aerosol generating material;
one or more battery properties; and
one or more user settings.

23. A non-combustible aerosol generating device comprising an apparatus as claimed in claim 1.

24. A non-combustible aerosol generating device as claimed in claim 23, wherein the aerosol generating device is configured to receive a removable article comprising an aerosol generating material.

25. A non-combustible aerosol generating device as claimed in claim 24, wherein said aerosol generating material comprises an aerosol generating substrate and an aerosol forming material.

26. A non-combustible aerosol generating device as claimed in claim 23, wherein the apparatus comprises a tobacco heating system.

27. A kit of parts comprising an article for use in a non-combustible aerosol generating system, wherein the non-combustible aerosol generating system an aerosol generating device as claimed in claim 23.

28. A kit of parts as claimed in claim 27, wherein the article is a removable article comprising an aerosol generating material.
